(19) United States
(12) Patent Application Publication
(10) Pub. No.: US 2014/0089023 A1
(43) Pub. Date: Mar. 27, 2014

(54) METHOD AND SYSTEM FOR DISTRIBUTING DATA STREAM

(71) Applicant: TENCENT TECHNOLOGY (SHENZHEN) COMPANY LIMITED, Shenzhen (CN)

(72) Inventor: ZHOUWEI ZHU, Shenzhen (CN)

(73) Assignee: TENCENT TECHNOLOGY (SHENZHEN) COMPANY LIMITED, Shenzhen (CN)

(21) Appl. No.: 14/089,910

(22) Filed: Nov. 26, 2013

Related U.S. Application Data
(63) Continuation of application No. PCT/CN2013/082976, filed on Sep. 5, 2013.

(30) Foreign Application Priority Data
Sep. 14, 2012 (CN) 201210341267.8

(51) Int. Cl. G06Q 10/06

(52) U.S. Cl. CPC G06Q 10/063
USPC 705/7.11

(57) ABSTRACT

Methods and systems for distributing a data stream are provided. A response message containing business identification can be received by the business interaction platform. The response message can be sent from a data forwarding platform according to a data stream received by the data forwarding platform from a provider. A total amount of the data stream and distribution ratio information corresponding to the business identification can be obtained by the business interaction platform. A distribution calculation can be performed on the total amount of the data stream according to the distribution ratio information for a plurality of recipients. The distribution amount of each recipient can be obtained and sent by the business interaction platform to the third party platform for the data forwarding platform to divide the received data stream according to the distribution amount and to send the divided data stream to each recipient.

### CROSS-REFERENCES TO RELATED APPLICATIONS

This application is a continuation application of PCT Patent Application No. PCT/CN2013/082976, filed on Sep. 5, 2013, which claims priority to Chinese Patent Application No. CN201210341267.8, filed on Sep. 14, 2012, the entire contents of all of which are incorporated herein by reference.

### FIELD OF THE DISCLOSURE

The present disclosure relates to the field of data processing technology and, more particularly, relates to methods and systems for distributing and processing data stream.

### BACKGROUND

In current processes for distributing data stream, a third-party platform may receive data stream from a provider and then forward the data stream to a designated target recipient. The target recipient can then divide the data stream according to an agreed ratio with other recipient(s) and send the divided data to the other recipient(s).

Currently, the third-party platform can only forward the data stream to the designated target recipient. It is desirable for the third party platform to further distribute and divide the data stream and send the divided data directly to the recipient(s) that participates to receive a portion of the data stream. In other words, it is desirable if there is no participation of any recipient during the processes for distributing the data stream.

### BRIEF SUMMARY OF THE DISCLOSURE

According to various embodiments, there is provided a method for distributing a data stream. A response message containing business identification sent from a data forwarding platform according to a data stream, received by the data forwarding platform from a provider, can be received by the business interaction platform. A total amount of the data stream and distribution ratio information corresponding to the business identification can be obtained by the business interaction platform. A distribution calculation can be performed by the business interaction platform on the total amount of the data stream according to the distribution ratio information for recipients. The distribution amount of each recipient of a plurality of recipients can be obtained by the business interaction platform. The distribution amount of the each recipient can be sent by the business interaction platform to the third party platform for the data forwarding platform to divide the received data stream according to the distribution amount and to send the divided data stream to each recipient.

According to various embodiments, there is also provided a system for distributing a data stream. The system can include a third party platform and a business interaction platform. The third party platform can be configured to receive data stream from a provider, send a response message containing business identification to the business interaction platform, receive distribution amount of each recipient of recipients returned from the business interaction platform, divide the received data stream according to the distribution amount, and send the divided data stream to the each recipient of a plurality of recipients. The business interaction platform can be configured to receive the response message containing the business identification from the data forwarding platform, obtain total number of the data stream and the distribution ratio information corresponding to the business identification, calculate the total number of data stream for distribution according to the distribution ratio information to obtain the distribution amount of the each recipient, and send the distribution amount of the each recipient corresponding to the business identification to the data forwarding platform.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for distributing data stream in accordance with various disclosed embodiments;

FIG. 2 depicts an exemplary method for calculating data stream distribution in accordance with various disclosed embodiments;

FIG. 3 depicts an exemplary method for verifying calculated distribution amount and for settling data stream in accordance with various disclosed embodiments;

FIG. 4 depicts an exemplary system for distributing data stream in accordance with various disclosed embodiments;

FIG. 5 depicts an exemplary environment incorporating certain disclosed embodiments; and

FIG. 6 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

A third party platform often forward data stream to a designated target recipient and cannot distribute the data stream, i.e., a data forwarding platform. In an example involving money amount data stream distribution in e-commerce business, multiple money recipients may be involved during various business interactions. This requires money amount data stream distribution, paid by users, to be distributed according to a certain ratio among the multiple money recipients. However, the third-party platform only sends the received money amount data stream to one of the money recipients. The recipient who received the money amount data stream then divides the money amount data stream according to a negotiated ratio with other recipients, and then sends the divided money amount data stream to all of other recipients.

However, as disclosed herein, a network-side (as opposed to “off the network” or “off-line”) business interaction platform is used to facilitate a third-party platform to send data stream provided from a provider directly to all of the recipients and to automatically distribute the data stream.

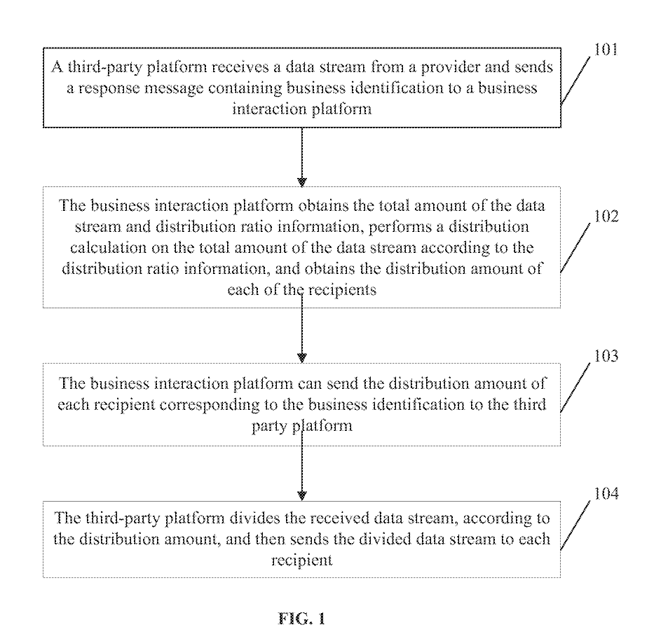

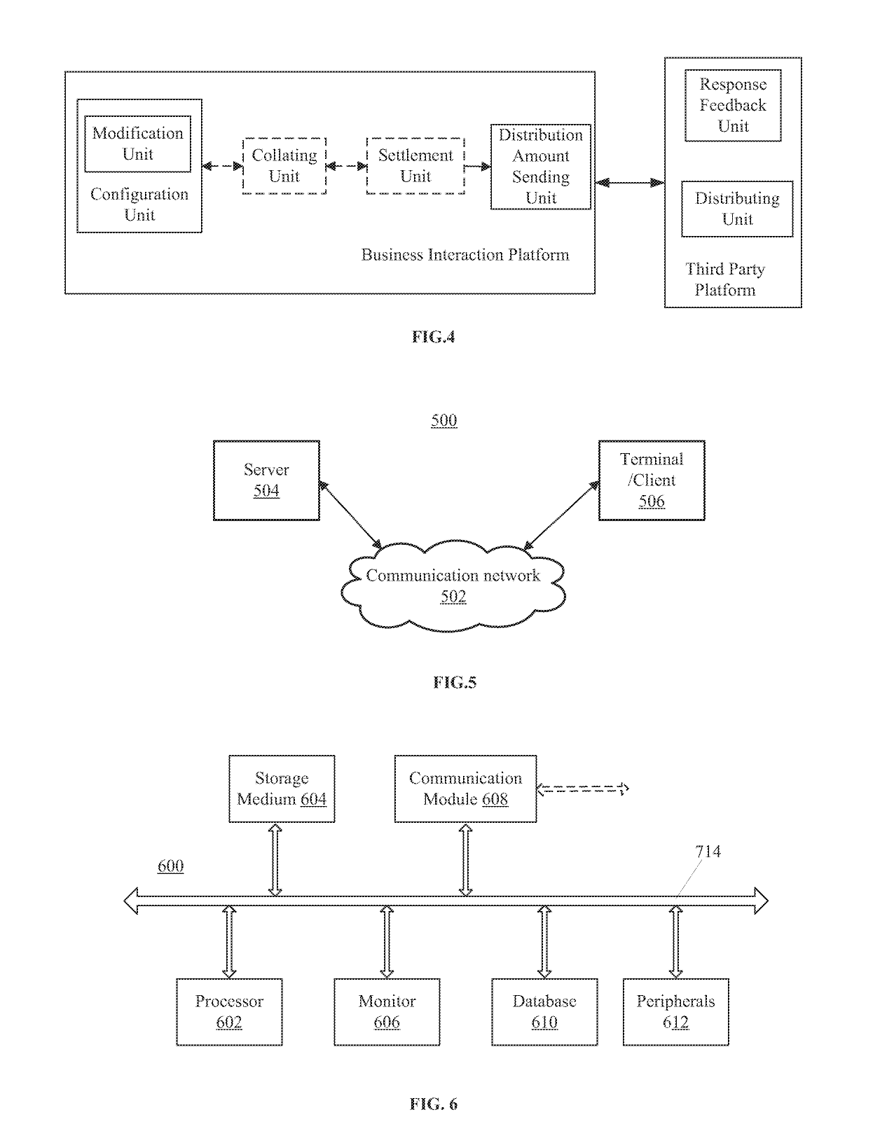

FIGS. 1-4 depict exemplary methods and systems for distributing and processing data stream in accordance with various disclosed embodiments. The exemplary methods and systems can be implemented, for example, in an exemplary environment 500 as shown in FIG. 5.

As shown in FIG. 5, the environment 500 can include a server 504, a terminal 506, and a communication network 502. The server 504 and the terminal 506 may be coupled through the communication network 502 for information exchange, for example, Internet searching, webpage browsing, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless. In various embodiments, the communication network 502 can be the network used for distribute and/or process data stream.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably.

A server, as used herein, may refer one or more server computers configured to provide certain server functionalities, for example, search engines and database management. A server may also include one or more processors to execute computer programs in parallel.

The server 504 and the terminal 506 can one or more of each party (e.g., a third party platform, provider, business interaction platform, etc.) for distributing data stream. The server 504 and the terminal 506 can be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, a storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, for example, ROM, RAM, and flash memory modules, and mass storages, for example, CD-ROM, U-disk, removable hard disk, etc. The storage medium 604 may store computer programs for implementing various processes, when executed by the processor 602.

Further, the peripherals 612 may include I/O devices, for example, keyboard and mouse, and the communication module 608 may include network devices for establishing connections through the communication network 502. The database 610 may include one or more databases for storing certain data and for performing certain operations on the stored data, for example, webpage browsing, database searching, data stream distribution, etc.

In operation, the terminal 506 may cause the server 504 to perform certain actions, for example, an Internet search or other database operations. The server 504 may be configured to provide structures and functions for such actions and operations. More particularly, the server 504 may include a data searching system for real-time database searching. In various embodiments, a terminal, for example, a mobile terminal involved in the disclosed methods and systems can include the terminal 506.

FIG. 1 depicts an exemplary method for distributing data stream in accordance with various disclosed embodiments.

In Step 101, a third-party platform receives a data stream from a provider and sends a response message containing business identification to a business interaction platform.

In Step 102, the business interaction platform obtains the total amount of the data stream and distribution ratio information corresponding to the business identification, performs a distribution calculation on the total amount of the data stream according to the distribution ratio information, and obtains the distribution amount of each of the recipients.

Different business types can correspond to different distribution ratio information. Business identification can include, for example, business order number. The business order number can identify corresponding business type. For example, the first four digits of the business order number can be used to indicate the business type. In this manner, the business type can be known based on the business order number. Distribution ratio information can be known based on the business type.

The distribution ratio information can include information used to calculate data stream shared by each of the recipients. For example, formula with parameters can be used, and the parameters can be modified as needed. Accordingly, the business interaction platform can receive a modification request with respect to the distribution ratio information to modify parameter of the distribution ratio information.

In Step 103, the business interaction platform can send the distribution amount of each recipient corresponding to the business identification to the third party platform.

In Step 104, the third-party platform divides the received data stream, according to the distribution amount, and then sends the divided data stream to each recipient.

Optionally, in order to improve accuracy of the data distribution, prior to performing Step 104, the distribution amount of each recipient can be collated.

For example, after the distribution amount of each of the recipients is obtained in Step 102, the disclosed method can further include that the business interaction platform generates distribution calculation results, which contains the distribution amount of each recipient corresponding to the business identification.

In another example, after performing Step 103, the disclosed method can further include: the third-party platform records the distribution amount of each recipient corresponding to the business identification in actual distribution results; the business interaction platform can obtain the actual distribution results from the third party platform and compare the distribution amount obtained from the distribution calculation results and from actual distribution results. Once the distribution calculation is collated (for example, the actual amount is the same as the calculated amount), the collated distribution amount can be recorded in distribution check results.

Further, after the distribution amount is collated by checking and recorded in the distribution check results, the disclosed method can further include:

The business interaction platform receives a withdrawal information containing business identification from the third party platform, the withdrawal information can be recorded in the distribution check results; the business interaction platform can obtain statistical settlement results summarized from the distribution check results and then send to the third-party platform. The statistical settlement results can include the distribution amount of each recipient corresponding to the business identification that needs distribution calculation.

Accordingly, the Step 104 can include that the third-party platform divides the received data stream and sends to each recipient according to a record of the statistical settlement results.

Further, after the third-party platform distributes the divided data stream to each recipient in Step 104, the method may further include that the third-party platform records the data stream distribution information into the actual settlement results.

The business interaction platform can obtain the actual settlement results from the third-party platform to collate the distribution amounts obtained from the statistical settlement results and from the actual settlement results. Once the distribution calculation is collated (i.e., the actual amount is the same as the calculated amount), the collated distribution amount can be recorded in the distribution check results.

Further, after the collated distribution amount is recorded in the distribution check results, the disclosed method can further include that the business interaction platform receives actual withdrawal information containing business identification from the third party platform, the actual withdrawal information can be recorded in the distribution check results.

As disclosed herein, a network-side business interaction platform is used to facilitate a third-party platform to send data stream provided from a provider directly to each of recipients, to automatically distribute the data stream.

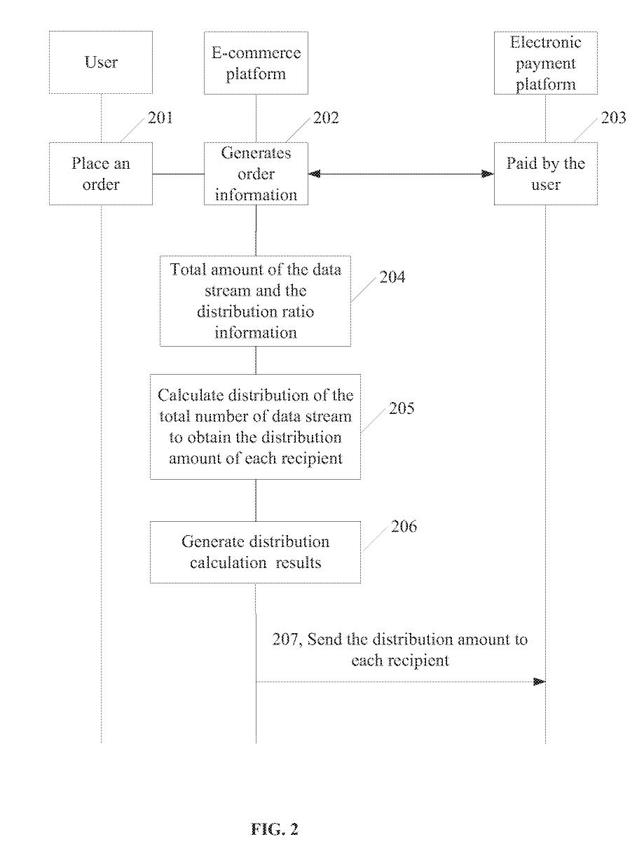

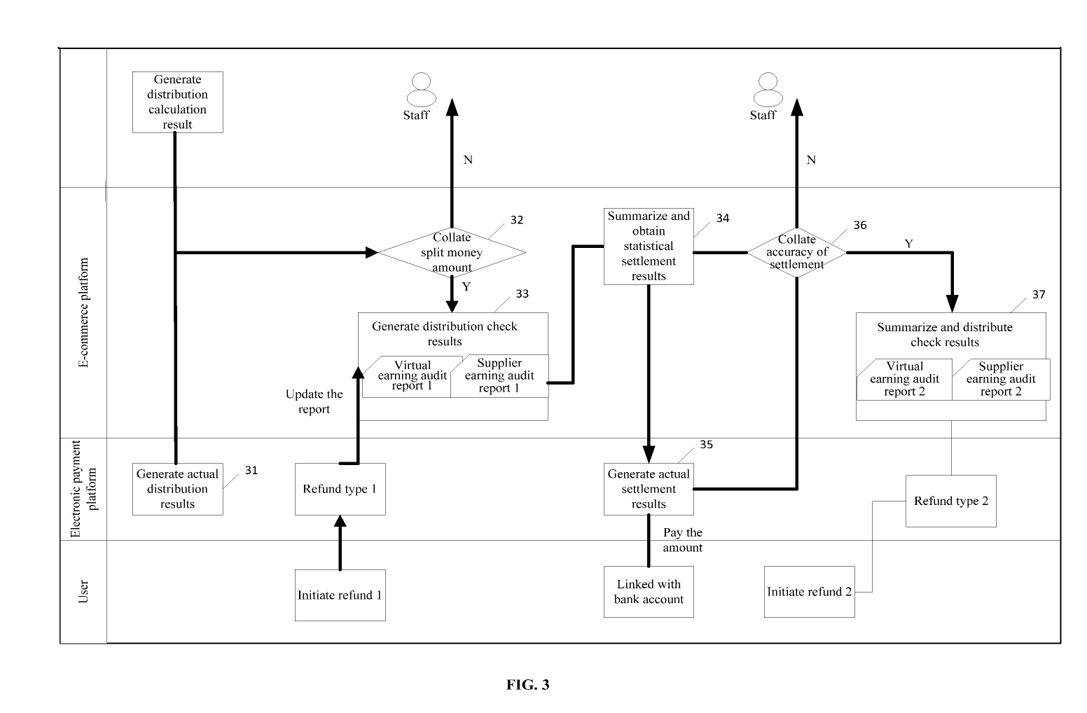

FIGS. 2-3 depict an exemplary method for distributing data stream involving e-distribution in accordance with various disclosed embodiments. In this example, an example of a data stream for distribution includes money amount data stream; an example of a business interaction platform is e-commerce platform; and an example of a third-party platform is an electronic payment platform. FIG. 2 depicts an exemplary method for calculating data stream distribution.

In Step 201, an e-commerce platform receives the user's login data and, after validation, obtains action information when the user places an order.

In Step 202, the e-commerce platform generates order information in the order system and initiates a payment request to the electronic payment platform.

Order information can include, for example, user information, business order number, and/or payment identification. Order information can also include, for example, a total money amount of the data stream that a user needs to pay including e.g., the sale price and/or supply price of products.

In Step 203, after the electronic payment platform confirms the user's payment, the electronic payment platform returns information for the successful payment containing the business order number to the e-commerce platform. That the electronic payment platform confirms the user's payment action means the electronic payment platform accepts the money amount paid by the user.

In Step 204, the e-commerce platform obtains the total amount of the data stream and the distribution ratio information corresponding to the business order number contained in the payment information.

The order information generated in Step 202 contains the business order number and the total amount of the data stream. Accordingly, the total amount of the data stream can be obtained according to the business order number contained in the payment information.

Different business types can correspond to different distribution ratio information. Business identification can include, for example, business order number. The business order number can identify corresponding business type. For example, the first four digits of the business order number can be used to indicate the business type. In this manner, the business type can be known based on the business order number. Distribution ratio information can be known based on the business type.

As required by practical needs, the business interaction platform can be configured to have different distribution ratio information for different business types. As disclosed herein, business identification can include, for example, business order number. The business order number can identify a corresponding business type. For example, the first four digits of the business order number can be used to indicate the business type. In this manner, the business type can be known based on the business order number. Distribution ratio information can be known based on the business type.

The distribution ratio information can include information used to calculate data stream shared by each of the recipients. For example, formula with parameters can be used. In one example, assuming there are four recipients: an electronic payment platform recipient (e.g., a third party), a supplier recipient, a distributor recipient, and an e-commerce platform recipient, data stream ratio information for each recipient can include the ratio formula as follows: electronic payment platform recipient: T %; supplier recipient: N/M×99.7%; distributor recipient: F %; e-commerce platform recipient: 1−(T %+N/M×99.7%+F %), wherein M is sale price of a product, N is supply price of the product, and T or F is a constant parameter and can be modified as needed.

Order information can include product sale price M and supply price N. Once M and N are determined, distribution ratio of recipients can be obtained according to the ratio formula.

In Step 205, the e-commerce platform can calculate distribution of the total number of data stream to obtain the distribution amount of each recipient, according to the distribution ratio information. Multiplying the sale price M of the product by the distribution ratio of each recipient, the distribution amount of each recipient can be received.

In Step 206, the e-commerce platform generates distribution calculation results. The distribution results contain distribution amount of each recipient corresponding to business identification.

In Step 207, the e-commerce platform sends the distribution amount of each recipient corresponding to the business identification to the electronic payment platform.

FIG. 3 depicts an exemplary method for verifying the calculated distribution amount and for settling the data stream in accordance with various disclosed embodiments.

In Step 31, the electronic payment platform receives distribution amount of each recipient corresponding to the business order number from the e-commerce platform and records in the actual distribution results.

In Step 32, the e-commerce platform obtains the actual distribution results from the electronic payment platform. The distribution amounts obtained from the distribution calculation results and from the actual distribution results are collated. Once the distribution calculation is collated (e.g., the actual amount is the same as the calculated amount), the collated distribution amount can be recorded in distribution check results.

For a same business order number, when the distribution amount from the distribution calculation results is the same as the distribution amount recorded in the actual distribution results, it is considered collated. Otherwise, when the distribution amount from the distribution calculation results is not the same as the distribution amount recorded in the actual distribution results, it is considered that the verification fails. The failure information can be sent to related staff.

After receiving the distribution check results, reports can be generated in a prescribed format and sent to a demanding side. For example, a supplier earning audit report 1, as requested by the suppliers, can be generated. In another example, a virtual earning audit report 1 used by the e-commerce platform and saved for their own can be generated.

In Step 33, the e-commerce platform receives withdrawal information containing business identification from the electronic payment platform. The withdrawal information can be recorded in the distribution check results.

At this stage, the type of withdrawal information can be denoted as refund type 1. The user can initiate a refund request to the electronic payment platform. The electronic payment platform sends the withdrawal information back to the e-commerce platform.

In Step 34, the e-commerce platform can obtain statistical settlement results summarized from the distribution check results and send to the e-payment platform. The statistical settlement results can include the distribution amount of each recipient corresponding to the business identification that needs distribution calculation.

The statistical settlement results summarized from the distribution check results can include obtaining the withdrawal information containing the business order number, removing records regarding the business order number from the distribution check results, and obtaining statistical settlement results.

In Step 35, the electronic payment platform divides the received data stream according to the statistical settlement results and sends to each recipient. The data stream distribution information can be recorded in the actual settlement results.

The electronic payment platform divides the money amount according to the records of the statistical settlement results and sends to association bank account of each recipient. The actual settlement results can include records of the money amount data stream actually sent to each recipient.

In Step 36, the e-commerce platform obtains the actual settlement results from the electronic payment platform. Distribution information of the data stream from the statistical settlement results and from the actual settlement results can be collated. The collated distribution information of the data stream can be recorded in the distribution check results.

For a same business order number, when the distribution amount from the actual settlement results is the same as the distribution amount recorded in the statistical settlement results, it is considered collated. Otherwise, when the distribution amount from the actual settlement results is not the same as the distribution amount recorded in the statistical settlement results, it is considered that the verification fails. The failure information can be send to related personal.

In Step 37, e-commerce platform receives actual withdrawal information containing business order number from the electronic payment platform. The actual withdrawal information is recorded in the distribution check results.

At this stage, the type of withdrawal information can be denoted as refund type 2. The user can initiate a refund request to the electronic payment platform. The electronic payment platform can send the withdrawal information back to the e-commerce platform.

After the distribution check results are obtained, reports in a prescribed format can be generated and sent to the demanding side. For example, a supplier earning audit report 2 requested by the suppliers can be generated. In another example, a virtual earning audit report 2 used by the e-commerce platform and saved for their own can be generated.

The finally generated distribution check results can be the actual money amount settlement report for related staff to perform data statistics, query, etc.

As disclosed herein, distribution of money amount data stream achieves a real-time dynamic split transaction. The real-time split of the transaction can be achieved with respect to price changes of the product to achieve a split ratio (e.g., distribution ratio) for each of various stakeholders or recipients. In addition, the real reconciliation can allow an instant alarm when split information error appears during the transaction. By multiple data validation, the settlement/account report can be safe and accurate to ensure security of the split, reconciliation, settlement, etc. The settlement reports (or statements) can support changes in the payment information for real-time data updates to ensure accurate settlement data.

FIG. 4 depicts an exemplary system for distributing data stream in accordance with various disclosed embodiments. The exemplary system can include a third party platform and/or a business interaction platform.

The third-party platform is configured to receive data stream from a provider, send a response message containing business identification to the business interaction platform; receive distribution amount of each recipient returned from the business interaction platform and divide the received data stream in accordance with the distribution amount and send to each recipient.

The business interaction platform is configured to receive the response message containing the business identification from the third-party platform, obtain the total number of the data stream and the distribution ratio information corresponding to the business identification. In accordance with the distribution ratio information, the total number of data stream is calculated for distribution to obtain the distribution amount of each recipient. The distribution amount of each recipient corresponding to the business identification can be sent to the third-party platform.

Optionally, the third party platform can include a response feedback unit and a distributing unit. The business interaction platform can include a configuration unit and a distribution amount sending unit.

The response feedback unit is configured to receive data stream from the provider, send to the distributing unit, and send the response message containing business identification to the configuration unit.

The configuration unit is configured to receive the response message containing business identification, obtain the total amount of the data stream and distribution ratio information corresponding to the business identification, in accordance with the distribution ratio information perform a distribution calculation on the total amount of the data stream, obtain distribution amount of each recipient, and send to the distribution amount sending unit.

The distribution amount sending unit is configured to send the distribution amount of each recipient to the distributing unit. The distributing unit is configured to receive the distribution amount of each recipient from the distribution amount sending unit in accordance with the distribution amount, and send to each recipient after dividing the received data stream.

Optionally, the configuration unit includes a modification unit configured to receive a modification request with respect to the distribution ratio information to modify parameters in the distribution ratio information. Optionally, the business interaction platform further includes a collating unit.

The configuration unit is further configured, after receiving the distribution amount of the each recipient, to generate distribution calculation results. The distribution calculation results can include the distribution amount of the each recipient corresponding to the business identification.

The distributing unit is further configured to, after receiving the distribution amount of each recipient from the distribution amount sending unit, record the distribution amount of each recipient corresponding to the business identification in the actual distribution results.

The collating unit is configured to obtain the actual distribution results from the distributing unit, to obtain distribution calculation results from the configuration unit, and to collate and verify the distribution amount information from the distribution calculation results and from the actual distribution results; and to record the collated distribution amount information in the distribution check results.

Optionally, the business interaction platform further includes a settlement unit (or an accounting unit). The collating unit is also configured to, after recording the collated distribution amount information in the distribution check results, receive withdrawal information containing the business identification from the third-party platform, and record the withdrawal information in the distribution check results.

The settlement unit is configured to obtain the distribution check results from the collating unit, summarize the distribution check results to obtain the statistical settlement results, and send to the distribution amount sending unit. The statistical settlement results can contain the distribution amount of each recipient corresponding to the business identification that needs distribution settlement.

The distribution amount sending unit is further configured to send the statistical settlement results to the distributing unit. The distributing unit is also configured to, according to the records of the statistical settlement results, divide the received data stream and send to each recipient.

In e-commerce transactions, a user purchases a product (e.g., calls). After paying appropriate money amount, the configuration unit can pull information of purchased product (including, e.g., order ID, supplier, supply price, sale price, etc.), obtain distribution ratio information of this order in real-time, and calculate the split money amount for the involved recipients or stakeholders and send the generated split money amount to the collating unit. The collating unit and the settlement unit are configured, depending on the split money amount information transmitted by the configuration unit, collate and summarize with the actual split data from the third party platform and send to the third party platform to generate settlement reports and send to the third-party platform. The third-party platform can then pay the money amount in accordance with the settlement reports.

In conventional e-commerce transactions, money amount can only be split off line according to the agreed ratio to complete the split transaction, which cannot provide a real-time dynamic split transaction once price changes (e.g., due to suppliers, sale channels, selling time, and other factors). As disclosed, by combining with the distribution ratio information, the real-time dynamic split transaction can be achieved in the network side according to the price of each order. In addition, after the real-time dynamic split transaction, refund information can be recorded to update the transaction data in real time.

It should be noted that, in the present disclosure each embodiment is progressively described, i.e., each embodiment is described and focused on difference between embodiments. Similar and/or the same portions between various embodiments can be referred to with each other. In addition, exemplary apparatus is described with respect to corresponding methods.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

As disclosed herein, a network-side (as opposed to “off the network” or “off-line”) business interaction platform is used to facilitate a third-party platform to send data stream provided from a provider directly to all of the recipients and to automatically distribute the data stream.

In e-commerce transactions, a user purchases a product (e.g., calls). After paying appropriate money amount, the configuration unit can pull information of purchased product (including, e.g., order ID, supplier, supply price, sale price, etc.), obtain distribution ratio information of this order in real-time, and calculate the split money amount for the involved recipients or stakeholders and send the generated split money amount to the collating unit. The collating unit and the settlement unit are configured, depending on the split money amount information transmitted by the configuration unit, collate and summarize with the actual split data from the third party platform and send to the third party platform to generate settlement reports and send to the third-party platform. The third-party platform can then pay the money amount in accordance with the settlement reports.

In conventional e-commerce transactions, money amount can only be split off line according to the agreed ratio to complete the split transaction, which cannot provide a real-time dynamic split transaction once price changes (e.g., due to suppliers, sale channels, selling time, and other factors). As disclosed, by combining with the distribution ratio information, the real-time dynamic split transaction can be achieved in the network side according to the price of each order. In addition, after the real-time dynamic split transaction, refund information can be recorded to update the transaction data in real time.

What is claimed is:

1. A method for distributing a data stream comprising:
receiving, by a business interaction platform, a response message containing business identification sent from a data forwarding platform according to a data stream received by the data forwarding platform from a provider;
obtaining, by the business interaction platform, a total amount of the data stream and distribution ratio information corresponding to the business identification;
performing, by the business interaction platform, a distribution calculation on the total amount of the data stream according to the distribution ratio information for a plurality of recipients;
obtaining, by the business interaction platform, the distribution amount of each recipient of the plurality of recipients; and
sending, by the business interaction platform, the distribution amount of the each recipient to the third party platform for the data forwarding platform to divide the received data stream according to the distribution amount and to send the divided data stream to the each recipient.

2. The method of claim 1, further comprising:
receiving, by the business interaction platform, a modification request with respect to the distribution ratio information to modify parameter in the distribution ratio information.

3. The method of claim 1, wherein, after obtaining the distribution amount of the each recipient, the method further comprises:
generating, by the business interaction platform, distribution calculation results comprising the distribution amount of the each recipient corresponding to the business identification.

4. The method of claim 3, wherein after sending the distribution amount of the each recipient to the third party platform, the method further comprises:
recording the distribution amount of the each recipient corresponding to the business identification in actual distribution results by the data forwarding platform;
obtaining the actual distribution results from the third party platform by the business interaction platform;
collating the distribution amount obtained from the distribution calculation results and from the actual distribution results; and
recording the collated distribution amount in distribution check results.

5. The method of claim 3, wherein after recording the collated distribution amount in the distribution check results, the method further comprises:
receiving, by the business interaction platform, withdrawal information containing the business identification from the third party platform;
recording the withdrawal information in the distribution check results; and
obtaining statistical settlement results, by the business interaction platform, summarized from the distribution check results to send to the third party platform, wherein the statistical settlement results comprises the distribution amount of the each recipient corresponding to the business identification that needs distribution calculation.

6. The method of claim 5, wherein sending the distribution amount for the data forwarding platform to divide the received data stream according to the distribution amount and to send the divided data stream to each of recipients further comprises: the data forwarding platform divides the received data stream and sends to the each recipient according to a record of the statistical settlement results.

7. The method of any claim of claim 6, wherein after sending the distribution amount for the data forwarding platform to send the divided data stream to each of recipients, the method further comprises:
recording the data stream distribution information in actual settlement results by the data forwarding platform;
obtaining, by the business interaction platform, the actual settlement results from the data forwarding platform to collate the distribution amounts obtained from the statistical settlement results and from the actual settlement results; and
recording the collated distribution amount in the distribution check results.

8. The method of claim 7, wherein after recording the collated distribution amount in the distribution check results, the method further comprises:
receiving, by the business interaction platform, actual withdrawal information containing the business identification from the third party platform; and
recording the withdrawal information in the distribution check results.

9. A system for distributing a data stream comprising:
a third party platform and a business interaction platform, wherein:
the third party platform is configured to receive data stream from a provider, send a response message containing business identification to the business interaction platform, receive distribution amount of each recipient of a plurality of recipients returned from the business interaction platform, divide the received data stream according to the distribution amount, and send the divided data stream to the each recipient of the plurality of recipients; and
the business interaction platform is configured to receive the response message containing the business identification from the data forwarding platform, obtain total number of the data stream and the distribution ratio information corresponding to the business identification, calculate the total number of data stream for distribution according to the distribution ratio information to obtain the distribution amount of the each recipient, and send the distribution amount of the each recipient corresponding to the business identification to the data forwarding platform.

10. The system of claim 9, wherein the third party platform comprises a response feedback unit and a distributing unit, and the business interaction platform comprises a configuration unit and a distribution amount sending unit.

11. The system of claim 10, wherein:
the response feedback unit is configured to receive the data stream from the provider, send to the distributing unit, and send the response message containing the business identification to the configuration unit;
the configuration unit is configured to receive the response message containing the business identification, obtain a total amount of the data stream and distribution ratio information corresponding to the business identification, perform a distribution calculation on the total amount of the data stream according to the distribution ratio information, obtain the distribution amount of the each recipient, and send to the distribution amount sending unit;
the distribution amount sending unit is configured to send the distribution amount of the each recipient to the distributing unit; and
the distributing unit is configured to receive the distribution amount of the each recipient from the distribution amount sending unit in accordance with the distribution amount, and send to the each recipient after dividing the received data stream.

12. The system of claim 11, wherein the configuration unit comprises a modification unit, configured to receive a modification request with respect to the distribution ratio information to modify parameters in the distribution ratio information.

13. The system of claim 12, wherein the business interaction platform further comprises a collating unit, and wherein:
the configuration unit is further configured, after receiving the distribution amount of the each recipient, to generate distribution calculation results, wherein the distribution calculation results comprise the distribution amount of the each recipient corresponding to the business identification;
the distributing unit is further configured, after receiving the distribution amount of the each recipient from the distribution amount sending unit, to record the distribution amount of the each recipient corresponding to the business identification in actual distribution results; and
the collating unit is configured to obtain the actual distribution results from the distributing unit, to obtain the distribution calculation results from the configuration unit, and to collate the distribution amount information from the distribution calculation results and from the actual distribution results; and to record the collated distribution amount information in distribution check results.

14. The system of claim 13, wherein the business interaction platform further comprises a settlement unit, and wherein:
the collating unit is also configured, after recording the collated distribution amount information in the distribution check results, to receive withdrawal information containing the business identification from the data forwarding platform, and to record the withdrawal information in the distribution check results;
the settlement unit is configured to obtain the distribution check results from the collating unit, summarize the distribution check results to obtain statistical settlement results, and send to the distribution amount sending unit, wherein the statistical settlement results comprise the distribution amount of the each recipient corresponding to the business identification that needs distribution settlement;
the distribution amount sending unit is further configured to send the statistical settlement results to the distributing unit; and
the distributing unit is also configured, according to a record of the statistical settlement results, to divide the received data stream and send to the each recipient.
